(19) United States
(12) Patent Application Publication
(10) Pub. No.: US 2004/0041902 A1
(43) Pub. Date: Mar. 4, 2004

(54) Portable videoconferencing system

(75) Inventor: Richard G. Washington, Marble Falls, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Polycom, Inc.

(21) Appl. No.: 10/412,755

(22) Filed: Apr. 11, 2003

Related U.S. Application Data
(60) Provisional application No. 60/372,201, filed on Apr. 11, 2002.

(51) Int. Cl. H04N 7/14

(52) U.S. Cl. 348/14.01

(57) ABSTRACT

A portable videoconferencing system includes a camera, a monitor, speakers, a microphone or microphone array and processing means within a single housing. The portable videoconferencing system may additionally be provided with a docking means coupled to a network. The portable videoconferencing system optionally connects by wireless means to the network.

### CROSS-REFERENCE TO RELATED APPLICATION

This application claims the benefit of U.S. Provisional Application No. 60/372,201 filed Apr. 11, 2002.

### BACKGROUND OF THE INVENTION

1. Field of the Invention

The present invention relates generally to conferencing systems, and more particularly to a portable videoconferencing system and method.

2. Discussion of Prior Art

Videoconferencing is rapidly becoming a popular method of communication among corporations and individuals. Aside from face to face conversations between people, videoconferencing is the only available way for people to communicate both visually and audibly in real time. The ability to view gestures, facial expressions and graphical information in real time during a conference has significant advantages over conventional audio-only telephone conferences. In many situations, the use of videoconferencing avoids or significantly reduces the need for time consuming and expensive business travel.

Videoconferencing techniques are used by a wide range of people including, by way of example, engineers discussing designs, medical doctors discussing illnesses, and parents talking with their children in college. For example, engineers working for a company having facilities in the United States, Europe and Asia may advantageously use a videoconferencing system to discuss equipment modifications because they can view the equipment as they discuss it. Without a videoconferencing system the engineers would have to travel to one site where they can both view and discuss the equipment.

A disadvantage with conventional videoconferencing is that all of the sites involved in a conference must have videoconferencing equipment such as that shown in FIG. 1. Typically, a videoconferencing system 100 includes a camera 110, a display monitor 120, microphone(s) 130, speakers 140 and a central processing unit 150. Videoconferencing system 100 communicates with other devices using standard protocols IEEE 802.3, integrated services digital network (ISDN), T1 and E1. IEEE 802.3 is a standard for wired Local Area Network (LAN) communications such as the Ethernet. ISDN is a communication standard used for sending voice, video and data over digital telephone lines or normal telephone wires at data rate transfers of 64 Kbps. T1 is a dedicated phone connection, used predominantly by businesses, which supports data rates of 1.544 Mbits per second and consists of 24 individual channels, each of which supports 64 Kbits per second. E1 is the European digital transmission equivalent to the T1 Since this type of equipment can be expensive and some companies may not be able or willing to purchase it, this technology has not been fully utilized.

Another disadvantage with conventional videoconferencing system 100 is that its delicate, heavy, and bulky characteristics make it difficult to transport and set up. Consequently it is inconvenient if not impractical to share videoconferencing apparatuses between sites. Since the physical characteristics of current videoconferencing equipment make it impractical to routinely transport such equipment to remote sites and set it up, videoconferences are often not done and someone may have to travel to the remote site. A further disadvantage with conventional videoconferencing system 100 is that it is too bulky and expensive to set up in many offices or homes. Videoconferencing systems 100 are usually located in a meeting or boardroom within a company facility which has a large amount of space.

What is needed is a portable videoconferencing apparatus which is compact and which a user can easily transport to, and set up in, remote sites or in separate locations within a business site.

### SUMMARY OF THE INVENTION

A portable videoconferencing system comprises a housing; a microphone within the housing for capturing sounds; a video camera within the housing for capturing images; a speaker within the housing for broadcasting sounds; a video display within the housing for displaying images; and, a processing unit within the housing that is coupled to the microphone, the video camera, the speaker and the video display for processing incoming and outgoing audio/video signals. In one embodiment, the videoconferencing system additionally comprises a base unit into which the portable unit or appliance docks. The base unit may contain a power supply and/or network or other I/O connections. In yet another embodiment, the portable videoconferencing system comprises a general purpose notebook computer equipped with a built-in camera, microphone or microphone array, speakers and software for performing real-time protocol conversions between, for example, H.323 and Audio Codec 97.

### BRIEF DESCRIPTION OF THE DRAWINGS

FIG. 1 shows a prior art stationary videoconferencing terminal,

FIG. 2 is a block diagram of a network useful for videoconferencing;

FIG. 3 is a block diagram showing components in accordance with one embodiment of the invention;

FIG. 4A is a front view of an embodiment of the invention;

FIG. 4B is a rear view of the embodiment of FIG. 4A;

FIGS. 5A-5D are side views of the embodiment of FIGS. 4A and 4B in various positions with and without a base;

FIG. 6 is a block diagram showing hardware components of a videoconferencing pad in accordance with one embodiment of the invention;

FIG. 7 is a flow diagram showing the flow of incoming audio and video streams from a network through the system;

FIG. 8 is a flow diagram showing the flow of incoming audio and video streams from a camera and microphone array through the system;

FIG. 9A is a flowchart showing the software program flow for processing incoming audio and video streams from a network; and

FIG. 9B is a flowchart showing the software program flow for processing incoming audio and video streams from the camera and microphone array.

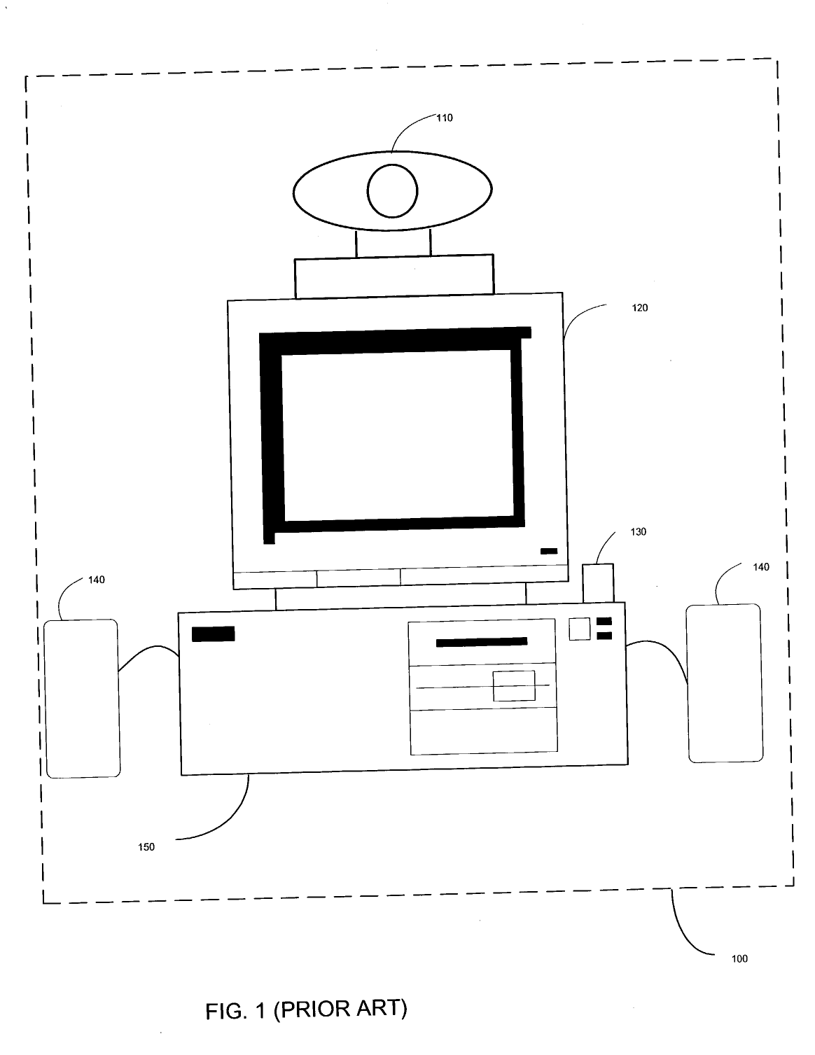

### DETAILED DESCRIPTION OF THE PREFERRED EMBODIMENT

The present invention provides a system and method for videoconferencing using portable videoconferencing equipment and software which are compact, easy to transport, and easy to set up.

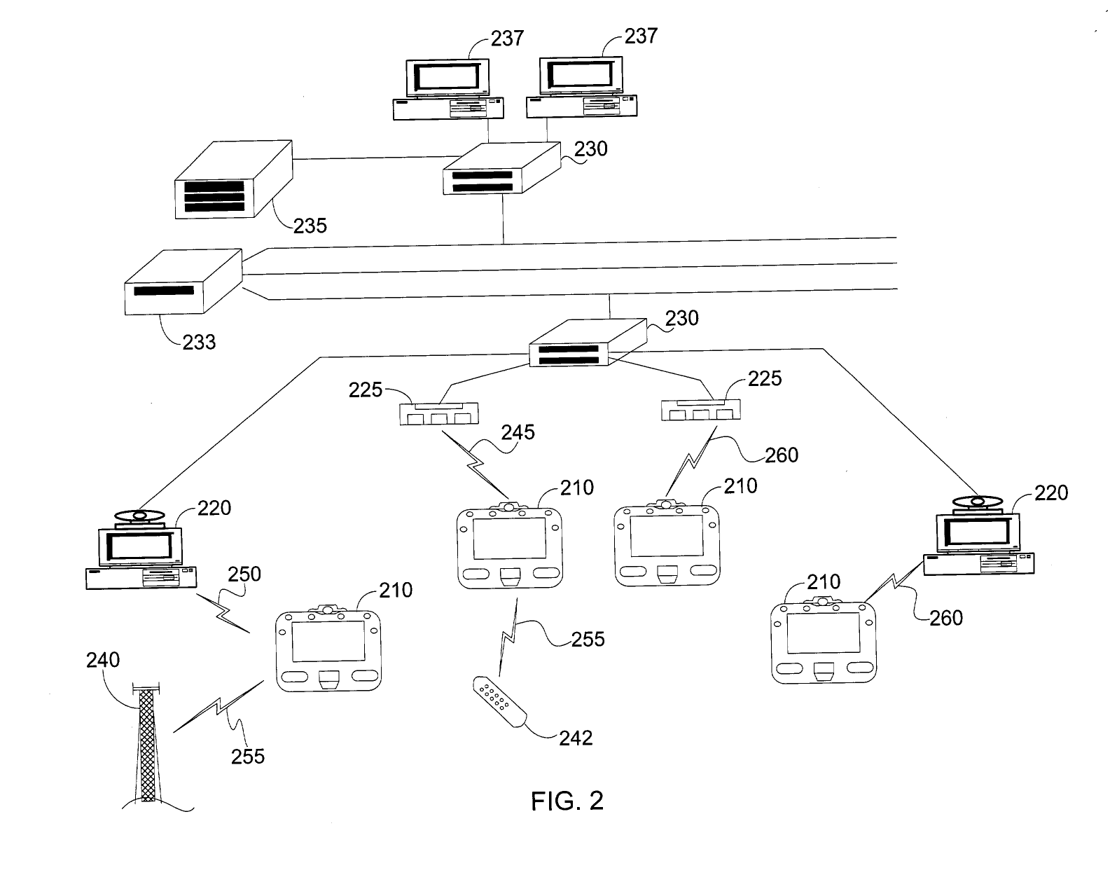

FIG. 2 depicts four exemplars of the inventive videoconferencing pad 210 in a network environment interacting with two conventional videoconferencing systems 220, two gateways 225, two switches or hubs 230, a router 233, a server 235, two personal computers 237, an antenna 240, and a cellular telephone 242. These network components 220-242 communicate according to standards including IEEE 802.11 245, Bluetooth 250, direct 2.5G-3G 255, and DoCoMo 260. Videoconferencing pad 210 can interface through an IEEE 802.11 245 or Bluetooth 250 interface directly to other videoconferencing devices 220.

Once a connection to a gateway 225 is established, the gateway establishes a Primary Rate Interface (PRI) link with a switch or hub 230. A PRI link typically uses four pairs of wires and provides more bandwidth than the usual T1 connections which use two pairs of wires. Switch or hub 230 is then connected to router 233 which routes the videoconference to the appropriate destination(s). Alternatively, videoconference pad 210 can use a high-speed multimedia data and voice 2.5G-3G coupling 255 to interact directly with a receiver such as an antenna 240. The 2.5G-3G coupling 255 is designed to deliver high-quality audio and video and to have advanced global roaming capabilities. An apparatus using a 2.5G-3G coupling 255 can operate anywhere by automatically handing off its signal to whatever wireless system is available such as a cellular telephone 242 which in turn relays the signal to an antenna using conventional communication standards such as IEEE 802.11 245 (not shown).

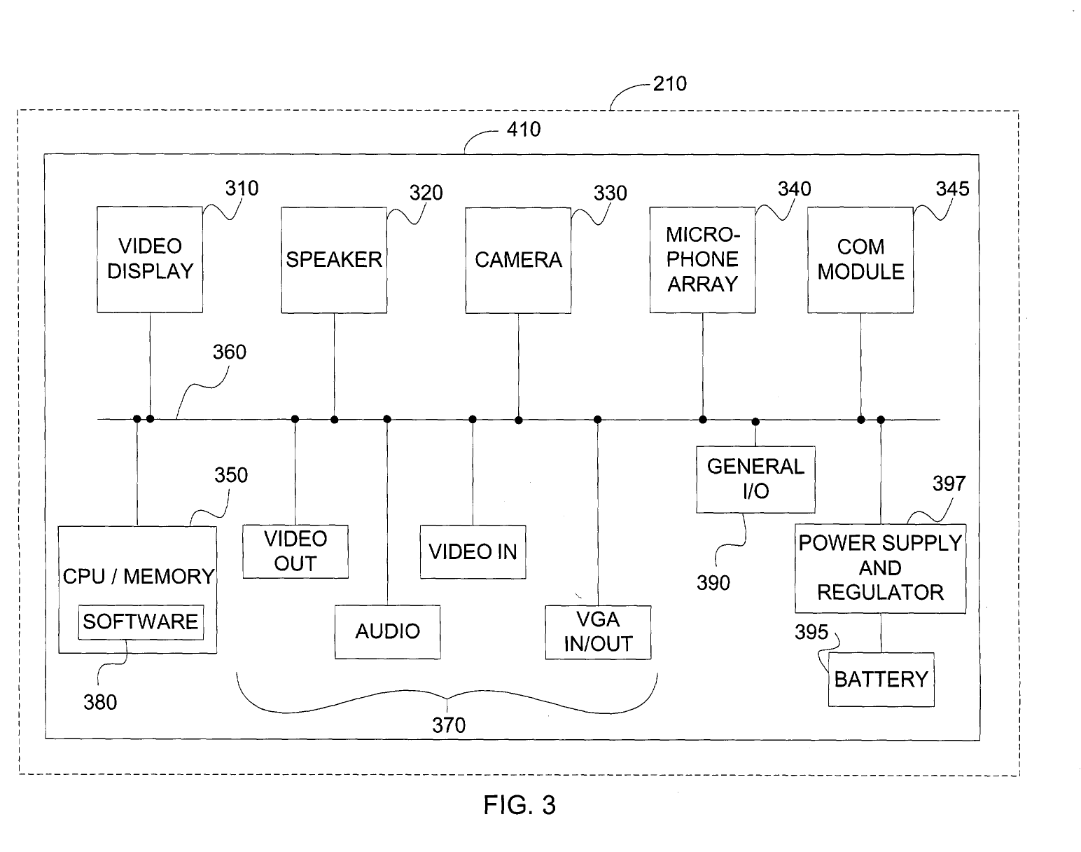

FIG. 3 represents an embodiment of videoconference pad system 210 which includes a housing 410, a video display 310, a speaker 320, a video camera 330, a microphone array 340, a communication (com) module 345, a central processing unit (CPU) with memory 350, a bus 360, a video and audio input and output (I/O) 370, software 380, and general inputs and outputs 390. Additionally, videoconference pad system 210 includes a battery 395 and a power supply and regulator 397 which can be connected to bus 360 if bus 360 is built to support a power line.

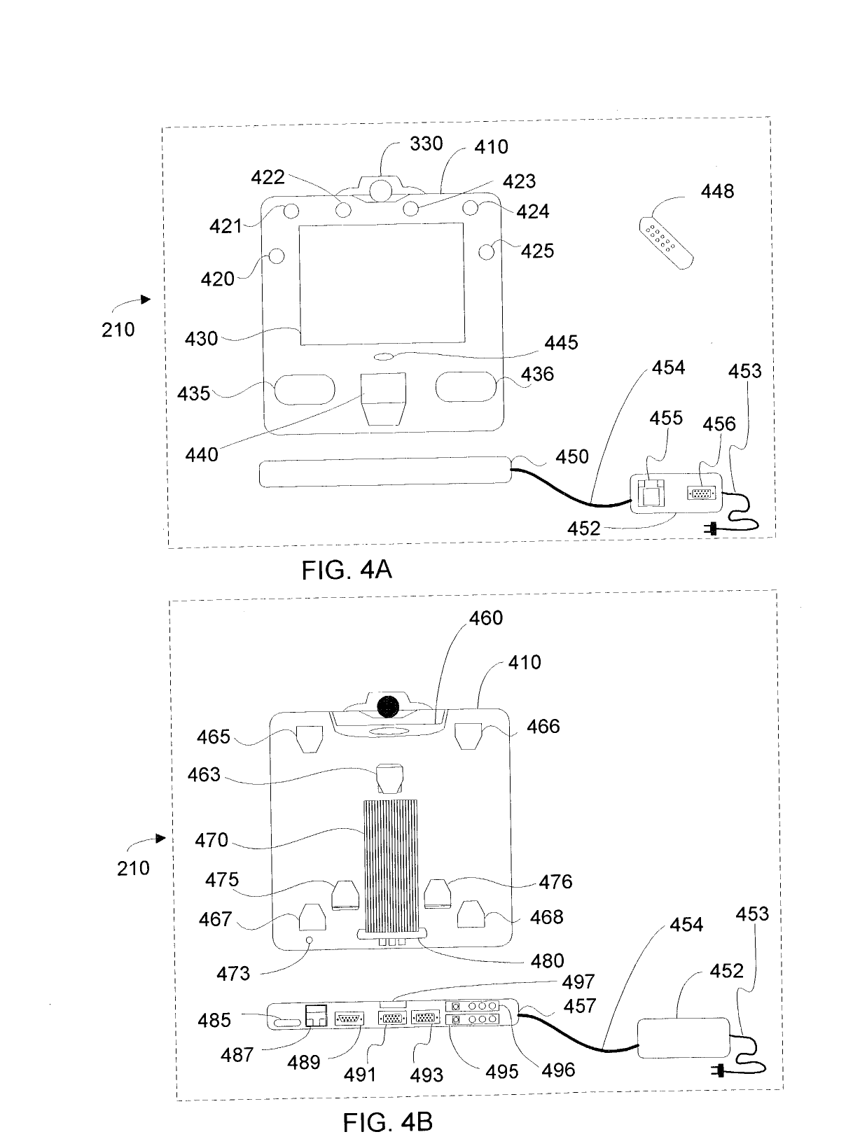

Housing 410 is discussed in more detail below with reference to FIGS. 4A and 4B.

Video display 310 can be a flat panel display, such as an LCD, PLED, plasma screen, or the like, and is capable of simultaneously displaying multiple active windows. Speaker 320 can be a speaker system with stereo capabilities. Camera 330 can be a high resolution CMOS camera mounted to videoconferencing pad 210 and is used to capture video images of videoconferencing participants. Similarly, microphone array 340 can be high performance acoustic sensors and is used to capture sounds in the videoconference room. Com module 345 is used to establish communications and can contain a PCI interface, wireless processing hardware and software, antenna(s), and an additional battery. CPU with memory 350 processes signals received through bus 360 from camera 330, microphone array 340 and video/audio I/O's 370. Software 380 includes an operating system, algorithms for processing video/audio signals and a graphical user interface (GUI) that enables users to control the videoconferencing pad 210. General I/O's 390 are used to attach the videoconferencing pad 210 to other electronic devices such as computers and external recording devices. Battery 395 may be a rechargeable battery such as a Lithium Ion, Nickel Cadmium or Nickel Metal Hydride battery.

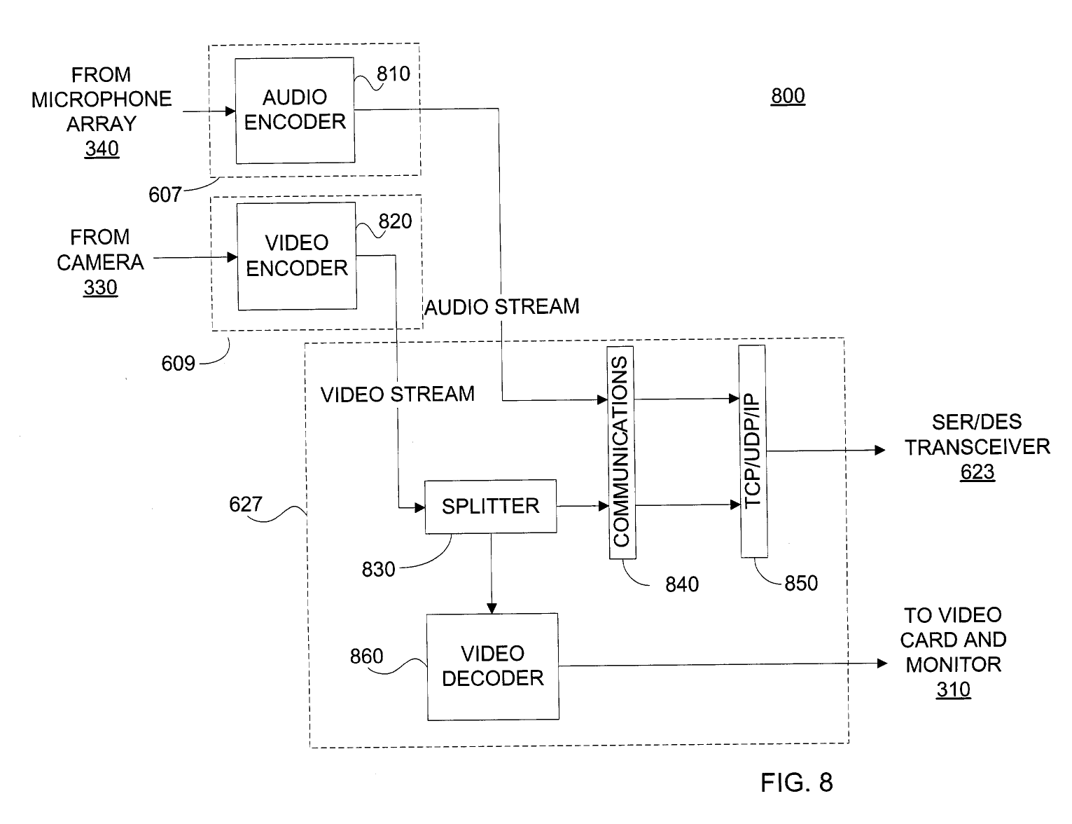

Housing 410 (FIGS. 4A, 4B) securely houses all of the components in FIG. 3 and battery 395 supplies power to these components, making videoconferencing system 210 portable. Camera 330 and microphone array 340 capture images and sounds in the room where videoconference system 210 is located and produce video and audio signals. Those signals are transmitted via bus 360 and processed by CPU and memory 350 using software 380, as further described in reference to FIG. 8, before video display 310 displays the video portion of the signal and signals are transmitted through corn module 345, video/audio input/output 370 and general inputs/outputs 390. Incoming video signals, generated by a second party participating in a video conference, are received through corn module 345, video/audio input/output 370 and general inputs/outputs 390, processed with CPU and memory 350 and software 380, routed through bus 360, displayed on video display 310 and broadcast through speaker 320.

FIG. 4A shows a front view of the preferred embodiment which includes a housing 410, a camera 330, a microphone array including a plurality of microphones 420, 421, 422, 423, 424 and 425, a screen 430 for the video display 310, speaker 320 units 435 and 436, a data entry device 440 such as a keypad, an infrared sensor 445, and a remote control input device 448 separate from the unit. To make videoconferencing pad 210 portable and easy to transport and use, housing 410 has built into it all of the equipment needed to conduct a videoconference, relieving the user of the need to position and connect wires between components such as cameras and speakers. The user can pick up the videoconferencing unit, carry it to another location, and easily set it up. Another advantage of the preferred embodiment is that it can be powered by a rechargeable battery, eliminating the need to locate a power outlet at a remote site.

In the best case setup scenario the user will have a fully charged battery, will choose to use the wireless connection features available on the unit, and will only need to turn the unit ON and use it, without making any connections. In the worst case setup scenario, the user will have an insufficiently charged battery and will choose to make a connection over the Internet through a directly wired LAN or through an external box that can interface with up to 4 ISDN lines using an H.320 link as discussed below with reference to FIG. 4B. In this case the user would need to connect the unit to a network jack and to a power outlet before using video conferencing pad 210. In either scenario, the set-up procedure is relatively simple and still much easier than wiring several components together.

The camera 330 used to capture the image of the videoconference participants is typically a high resolution CMOS camera positioned at the top center of the housing 410. System 210 can be equipped with a sensor to track the person talking and the camera 330 can be driven by one or more motor(s) to focus on the person talking or on any object in the room. One embodiment includes a motor drive mechanism that enables panning and tilting camera 330. In still other embodiments, a zoom feature is included. Panning, tilting and zooming may also be accomplished electronically using a suitably sized imager and a wide-angle lens. The microphones 420-425 are positioned on the housing 410 to maximize audio coverage of the room. In one preferred embodiment, four microphones 421, 422, 423 and 424 are positioned above video screen 425, and two microphones 420 and 425 are positioned on the sides of video screen 430. Screen 430 may be an LCD that can be used as a computer monitor when it is not being used in a videoconference call. Keypad 440, which has a full phone pad layout for speakerphone operation, can be a flip down unit that is securely closed for transportation. Additionally, keypad 440 may have function keys for instant GUI navigation (e.g. select video and audio conferences) as well as arrow keys that allow the user to move between windows and within windows much like the four arrow keys found on a conventional computer keyboard. Remote control device 448 is typically an infrared remote control device that transmits commands through infrared port 445 to the videoconferencing pad 210. Remote control 448 has the same keys as keypad 440 but allows the user to control the videoconferencing pad 210 from a distance.

FIG. 4A also shows a front view of base unit 450, which is a detachable part of videoconferencing pad 210, attached to a power module 452 through a cable 454. Base unit 450 is a standard base with no additional functionality. It can be replaced by an expanded base unit 457 which has additional functionality as further described with reference to FIG. 4B. Power module 452 converts conventional household electrical AC power, received through an AC power cord 453, into DC power and transmits the DC power to base unit 450 through cable 454. Additionally, power module 452 includes a LAN connection 455 and a VGA input 456 which are connected to the base unit 450 through cable 454 giving base unit 450 LAN and VGA access.

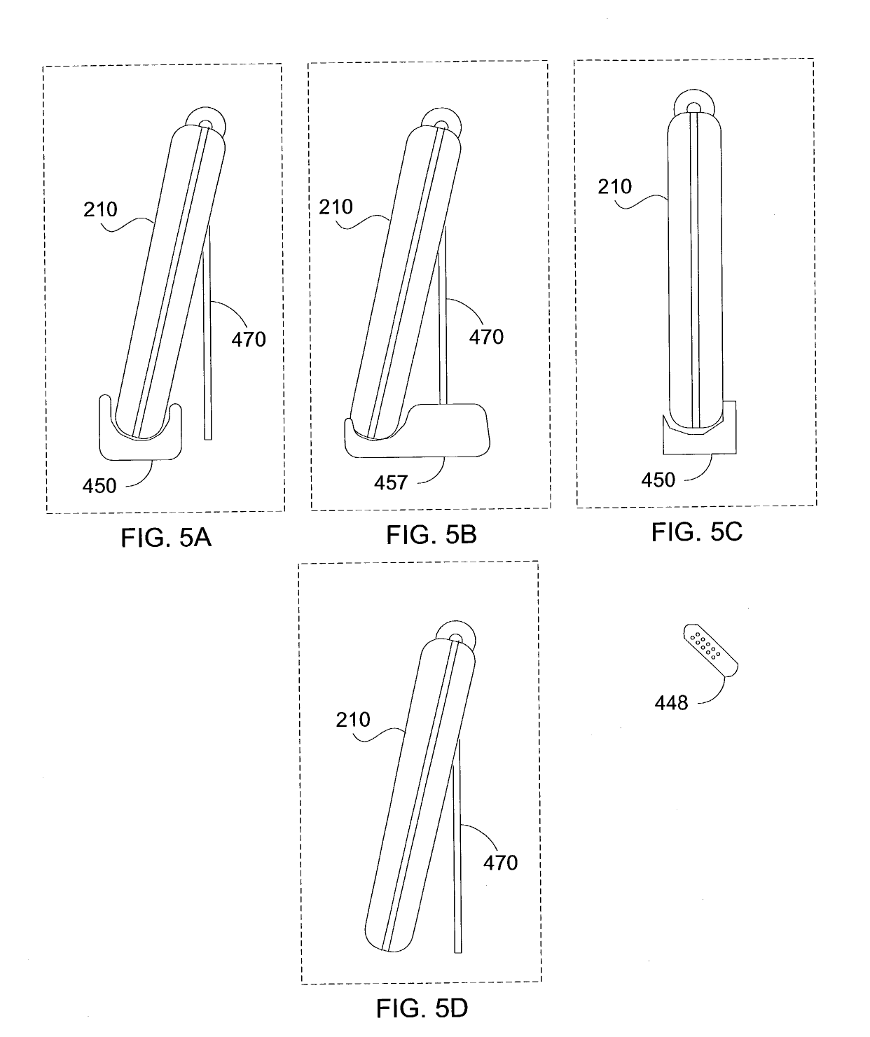

FIG. 4B shows a rear view of the embodiment of FIG. 4A which includes an inset handle 460, a remote control slot 463, multiple internal slots for NTT DoCoMo mobile link cards 465, 466, 467, 468, a back stand 470, a DC power cord 473, PCMCIA slots 475 and 476 and a base interface 480. Inset handle 460, which can be detachable or permanently attached to housing 410, is for picking up and carrying pad 210. Remote control slot 463 is for securely storing the remote control device 448 so that it can be transported safely. Internal slots for the NTT DoCoMo mobile link cards 465-468 are used to access wireless services through the NTT DoCoMo service provider. Back stand 470 supports videoconferencing pad 210 in an upright position and has one end hinged to the rear of pad 210 while the other end can be pulled out to rest on a horizontal surface, as shown in FIGS. 5A, 5B and 5D. DC power cord 473 is used to power videoconferencing pad 210 as well as to charge the rechargeable battery in videoconferencing pad 210. PCMCIA slots 475 and 476 are for using an IEEE 802.11 interface to connect to a LAN. Base interface 480 is a set of interconnects, such as gold-plated electrical connection pads, that allows videoconferencing pad 210 to be easily docked into interconnect 497 of the expanded base 457. A zero insertion force connection may advantageously be provided between videoconferencing pad 210 and base 450 and 457 because gravity may, in some embodiments, be the only force holding the two together. This feature makes videoconferencing pad 210 a “grab-and-go” device because the user only needs to pick up the videoconferencing pad 210 and carry it to a different location.

FIG. 4B also shows a rear view of one preferred embodiment of the extended base unit 457 which includes a Universal Serial Bus (USB) connector 485, an H.320 link 487, a serial I/O port 489, a VGA output port 491, a VGA input port 493, two audio/video I/O ports 495 and 496 and a base electrical interconnect 497. The relationship between videoconferencing pad 210 and base unit 457 is much like the relationship between a lap top computer and a docking station. To dock portable videoconferencing pad 210 it is placed on top of base unit 457 so that the electrical interconnects 480 on pad 210 line up with the base electrical interconnect 497 on base unit 457. Videoconferencing pad 210 weighs enough to maintain it securely on base unit 457. Base unit 457 expands the functionality of videoconferencing unit 210 by providing a USB connector 485 which is a hardware interface for low-speed peripherals such as a keyboard, mouse, joystick, scanner, printer or telephony devices. The USB connector 485 interface supports MPEG-1 and MPEG-2 digital video and has a maximum bandwidth of 12 Mbits/sec. H.320 link 487 facilitates videoconferencing over ISDN communication lines. Serial I/O port 489 allows base unit 457, along with videoconferencing pad 210, to be interfaced through an RS232 connection to external RS232 devices (not shown) such as cameras for image capturing and personal computers for purposes of debugging, programming or configuring base unit 457 and videoconferencing pad 210. VGA output 491 allows hooking up an external video monitor, such as a larger monitor for better viewing. VGA input 493 allows capturing of images from a computer, such as a laptop, for transmission to remote sites. Two audio and video Inputs/Outputs 495 and 496 enable the user to attach videoconferencing pad 210 to external devices such as videocassette recorders for recording a videoconference.

Additionally, FIG. 4B shows power module 452 with AC power cord 453 attached to extended base unit 457 through cable 454. The details of power module 452 were discussed above with reference to FIG. 4A.

Videoconferencing pad 210 can be transported by turning it OFF, picking it up by inset handle 460 and carrying it in the same way one would carry a laptop computer. Setting it up at its destination is done by turning it ON and, if a wireless connection is not available, connecting it to a communication port such as a phone jack. If the videoconferencing pad's battery 395 is not charged then power cord 473 must be plugged into a power outlet.

FIGS. 5A, 5B, 5C and 5D are side views of videoconferencing pad 210 in several positions. FIG. 5A shows pad 210 supported upright with a back stand 470 and mounted on a standard base 450 in a desktop position. Videoconference pad 210 connects to the standard base through the interconnects on base interface 480. Standard base unit 450 contains power and recharge circuitry along with VGA output 456, and LAN connections 455, and has a single output cable which contains a power cord, VGA in and LAN connections. FIG. 5B shows pad 210 mounted on an extended base 457 in a desktop position. In the embodiment illustrated in FIG. 4B, the extended base 457 has a USB port 485, a Polycom H.320 link 487 for attachment to H.320 peripherals (Quad BRI, PRI, etc.), a serial I/O 489, a VGA output 491, and additional audio/video I/O 495 and 496. FIG. 5C shows pad 210 mounted on a standard base 450 and supported in an upright position by a wall (not shown). Finally, FIG. 5D shows pad 210 supported upright by a back stand 470 in a desktop position without a base.

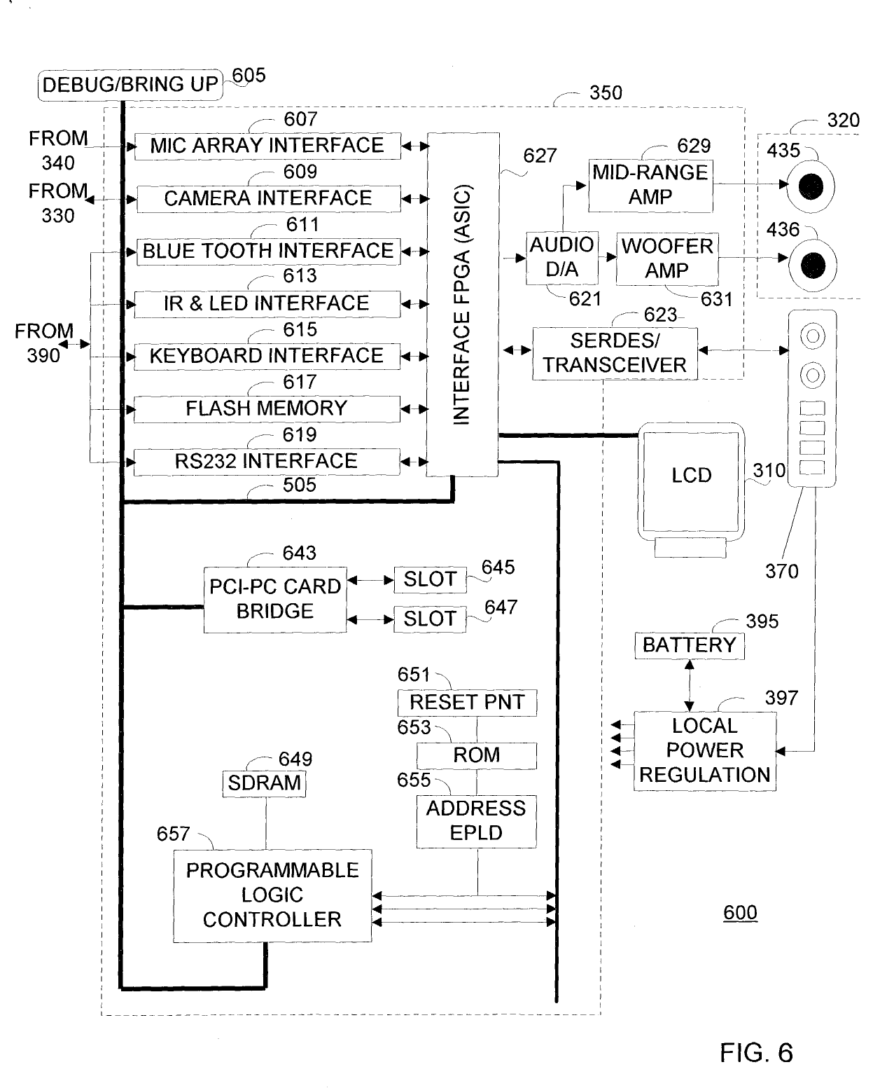

FIG. 6 is a block diagram of videoconferencing pad 210 in the preferred embodiment 600, which includes an expansion connector 605, details of CPU with memory 350, LCD 310, details of speaker system 320 (including two internal speakers 435 and 436), a video/audio input/output 370, local power regulator 397, and battery 395. CPU with memory 350 (FIG. 3) further includes a microphone array interface 607, a camera interface 609, a Blue Tooth interface 611, an IR and LED interface 613, a keyboard interface 615, flash memory 617, an RS232 interface 619, an audio D/A converter 621, a serializer-deserializer (SerDes)/Transceiver 623, all connected to a field programmable gate array (FPGA) interface 627. Additionally, CPU with memory 350 includes a mid-range amp 629, a woofer amp 631, a PCI-PC Card Bridge 643, two PCI-PC slots 645 and 647, an SDRAM 649, a reset point 651, a boot ROM 653, an address EPLD 655 and a programmable multi-media processor 657.

FPGA 627 interfaces with the various external inputs. As also shown in FIG. 8, the microphone array interface 607 receives its audio input from microphone array 340 and outputs it to FPGA 627 which routes it through the SerDes Transceiver 623 to the video/audio input/output 370 which in turn transmits it to the other calling parties. Camera interface 609 receives its video input from camera 330 and outputs it to the FPGA 627 in which splitter 830 splits the signal and routes part of it to LCD 310 and the other part through the SerDes Transceiver 623 to the video/audio input/output 370 which transmits it to the other calling parties. The Blue Tooth interface 611 interfaces FPGA 627 with devices that use the Blue Tooth open standard to transmit digital voice and data short ranges between mobile devices. Signals from external devices such as the remote control 448 are relayed through I/O 390 and IR and LED interface 613 to the FPGA 627 while signals from the keyboard or keypad 440 are relayed through I/O 390 and the keyboard interface 615 to the FPGA. Flash memory interface 617 connects flash memory (not shown), which stores recorded information such as accessing information, to the FPGA 627. RS232 interface 619 connects and controls FPGA 627 with external electronic RS232 devices (not shown) such as computers, cameras and electronic white boards for image capture.

After FPGA 627 processes information received from microphone array interface 607 and digital camera 609, the processed signals are transmitted to audio D/A converter 621, SerDes/Transceiver 623 and LCD 310. Audio D/A converter 621 processes the received signals and supplies them to mid-range amplifier 629 and bass amplifier 631 which drive internal speakers 435 and 436. The LCD 310 receives signals directly from FPGA 627 and uses them to display images on an electronic screen.

Both the LCD 310 and audio D/A converter 621 receive, through FPGA 627, signals which originated from another party or parties involved in the videoconference. Signals incoming from other members of a videoconference arrive through video/audio input/output 370, go through SerDes Transceiver 623 and are received by FPGA 627.

Base interface 480 also supports charging of battery 395. Docking videoconferencing pad 210 on base unit 450 forms a connection dedicated to charging battery 395. The energy used to charge the battery flows from a typical 110 volt AC electrical outlet to the base unit 450 or 457 where the voltage and current are converted from AC to DC. The DC electrical energy flows to the local power regulation unit 397 which may control the current and/or voltage to avoid overcharging or otherwise damaging battery 395.

Programmable multi-media processor 657, which controls SDRAM 649 and several inputs and outputs such as video in and video out, has a boot ROM 653 and an address EPLD 655 and can be reset with the use of the reset point 651. Expansion connector 605 connects both the PCI-PC card bridge 643 and the programmable multi-media processor 657 to an external personal computer or to one instantiation of the NTT DoCoMo interface. The programmable multi-media processor 657 is used in debugging of videoconferencing pad 210, typically with a personal computer. For example, an external computer can be used to debug the firmware by connecting the computer through the RS232 interface 619 to programmable multimedia processor 657 so that a programmer can monitor firmware execution and appropriately change code in the firmware.

PCI-PC card bridge 643 controls PC card slots 645 and 647, which may be a PCMCIA card, used to run LAN or Ethernet connections. PC card slots 645 and 647 can be IEEE 802.11 wireless LAN and IEEE 1394 card slots which allow for direct connection to an IEEE 1394 hard drive for digital recording of images captured in a local conference room or received from remote sites. Videoconferencing pad 210 can also connect to the LAN through the LAN connection 455 in the power module 452 when videoconferencing pad 210 is connected to the base 457 and 457.

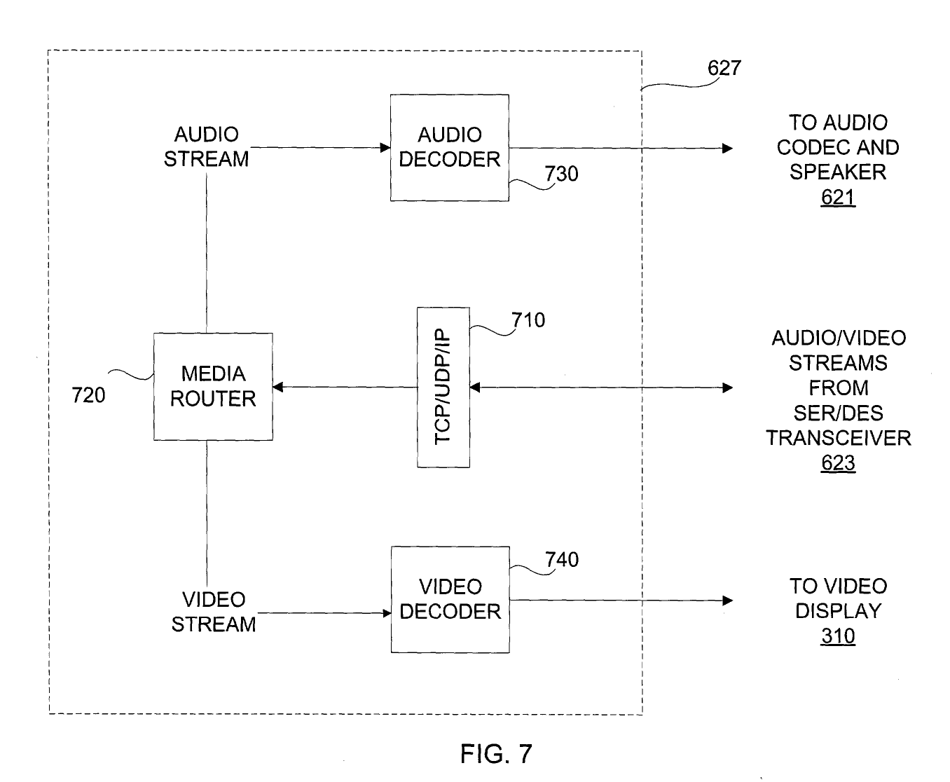

FIG. 7 is a block diagram showing the path of audio and video signals incoming from the network interface 623, through the FPGA 627. The block diagram includes a TCP/UDP/IP 710, a media router 720, an audio decoder 730, a video decoder 740, an audio D/A converter 621 and a video display 310. The incoming audio and video streams, which originated at one or more remote conference sites and represent the sounds and images of that site, are received through video/audio input/output 370 (FIG. 6), processed through serdes/transceiver 623 (FIG. 6) and processed by the TCP/UDP/IP stack 710, which performs error checking and removes header information from the incoming audio and video streams. Once the header information is removed by the TCP/UDP/IP stack 710, the audio and video streams are directed to the media router 720 which sends the audio stream to the audio decoder 730 and the video stream to the video decoder 740.

Media router 720 supplies the audio stream, minus the headers, to the audio decoder 730 which decodes the audio stream so that an audio D/A converter 621 can process it. Additionally, if multiple incoming audio streams are received, as would be the case with a multi-point videoconference, the audio decoder 730 mixes or switches the audio streams. The audio decoder 730 then transmits the decoded audio stream to audio D/A converter 621 which converts the digital signals to analog signals and passes the analog signals through amplifiers 629 and 631 to loudspeakers 435 and 436 that reproduce and broadcast the sounds from other remote videoconferencing sites.

Media router 720 sends the incoming video stream to the video decoder 740, which decodes the video stream. Video decoder 740 may also perform mixing or switching services if there are multiple video streams from different remote videoconferencing sites. The decoded video stream is subsequently transmitted to video display 310 which displays the images embodied in the decoded video stream in a window on a screen.

FIG. 8 is a block diagram showing the path 800 of the audio and video signals, which originate in the videoconference pad's 210 own microphone array 340 and video camera 330 respectively, through the FPGA 627. The path 800 includes an audio encoder 810 which is part of microphone array interface 607, a video encoder 820 which is part of camera interface 609, and details of FPGA 627. FPGA 627 further includes a splitter 830, a communications module 840, a TCP/UDP/IP 850 and a video decoder 860.

Audio signals originating from the microphone array 340 first go through the audio encoder 810 which encodes the audio stream with the appropriate protocol such as H.323 and may then go through a USB connection to communications module 840. The communications module packetizes the audio stream and passes the packets to a TCP/UDP/IP stack 850 which attaches header information to the audio stream and outputs the stream through SerDes 623 and video/audio input/output 370 for transmission over the Internet to one or more remote conference endpoints.

Video signals originating from the video camera 330 first go through the video encoder 820 which encodes the video stream with the appropriate protocol such as H.323 and then to splitter 830. Splitter 830 generates identical copies of the original signal and transmits one copy to the communication module 840 and the other copy to video decoder 860. The communications module processes the video stream copy in a manner similar to how the audio decoder 730 processes the audio stream. Communication module 840 packetizes the video stream and passes it to the TCP/UDP/IP stack 850 which attaches header information to the video stream and places the stream, through serdes/transceiver 623, on the video/audio input/output 370 for transmission over the Internet to one or more remote conference endpoints. The second copy of the video stream, transmitted to the video decoder 860, is decoded and transmitted to the video display 310, which displays the image embodied in the local video stream.

Splitter 830 enables the video stream from the camera 330 both to be transmitted to other videoconferencers and to be displayed on the user's own video display 310 so that he/she can view himself/herself. In some embodiments, the audio stream is not duplicated and played back to the user because it tends to interfere with the conversation.

Videoconferencing pad 210 may be additionally be used to transmit and view slide shows. The slide shows can be a collection of digital images captured by a digital camera or a collection of images generated with a computer software application such as Microsoft PowerPoint™ presentation software. Slide shows, which are typically stored in the memory of a personal computer, may be transferred to videoconferencing pad 210 through general I/O port 390. Once the signals reach videoconferencing pad 210 they may be processed and transmitted as ordinary video signals described with reference to FIG. 8 above. Furthermore, slide show images may be received and processed similarly to the video signals described with reference to FIG. 7 above.

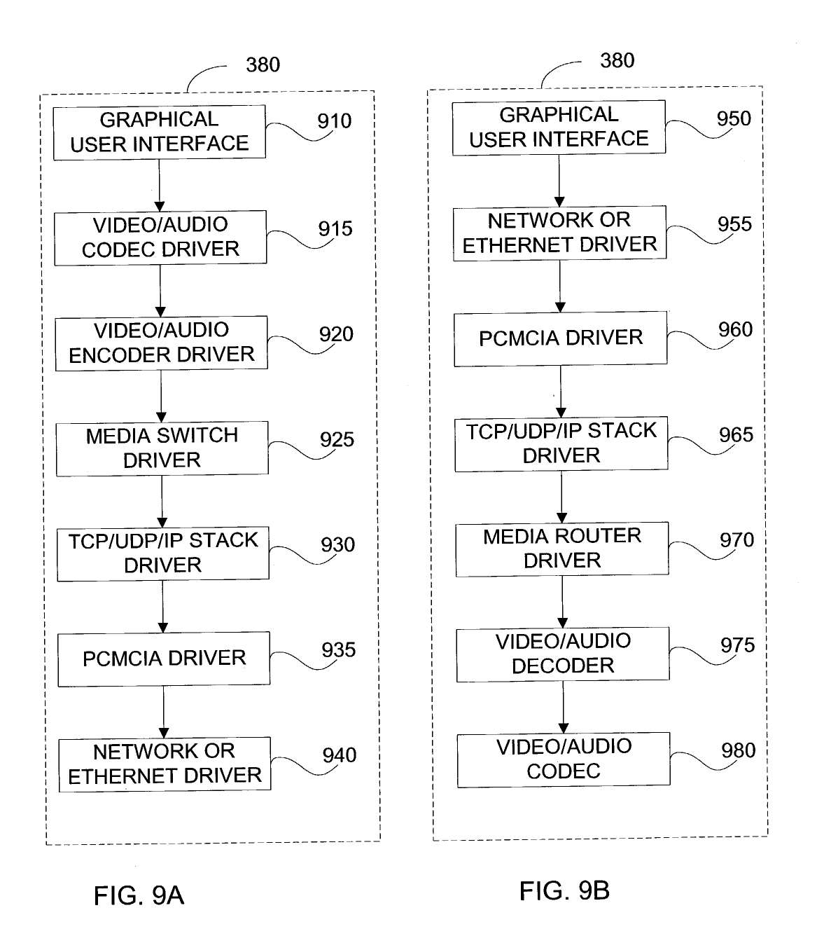

FIG. 9A shows the software components 380 which may be used by CPU 350 to process signals from video camera 330 and microphone array 340. The components illustrated include a graphical user interface (GUI) 910, a video/audio CoDec (Coder-Decoder) driver 915 that converts analog sound or video to digital code (analog to digital) and vice-versa (digital to analog), a video/audio encoder driver 920, a media switch driver 925, a TCP/UDP/IP STACK driver 930, a PCMCIA driver 935 and a network or Ethernet card driver 940.

The user interacts with the videoconferencing pad 210 through GUI 910 which allows the user to use a pointer/selector such as an infra-red remote control or an internal keyboard to manipulate the screens. The user can enter data through conventional keyboard or keypad 440, remote control keypad 448, or a soft keyboard that allows the user to enter keyboard characters by selecting keyboard elements on the screen with a pointer-selector device such as, for example, a light pen, touch pad, mouse, joystick or touch screen. Alternatively, an external keyboard or pointing device could be used to control the videoconferencing pad. Once information has been entered through the GUI, the operating system translates the entered information into commands to be executed by the firmware and software which run the videoconferencing pad 210. Although one preferred embodiment of videoconferencing pad 210 uses a custom operating system, it may use a conventional operating system such as Microsoft Windows® or Linux which may be configured for a videoconferencing application.

The audio/video output signals from the camera 330 and microphone array 340 are first processed by audio and video CoDec driver 915 respectively. After video/audio CoDec driver 915 has converted analog signals to digital signals the video/audio encoder driver 920 encodes the audio and video signals. The audio encoder 810 follows instructions from audio encoder driver 920 for applying the encoding protocol of ITU Recommendation G.711 (“Pulse Code Modulation (PCM) of Voice Frequencies”) to the local audio stream generated by microphone array 340 and audio CoDec driver 915. The G.711 protocol utilizes a PCM scheme to compress the local audio stream. Audio encoder driver 920 may be configured to support additional audio encoding algorithms, such as MPEG-1 audio and ITU Recommendations G.722, G.728, G.729 and G.723.1 or other proprietary or non-proprietary algorithms. The video encoder driver 920, which runs the video encoder 820, includes instructions for encoding common intermediate format (CIF) images in the local video stream supplied by video camera 330, in accordance with Recommendation H.263 (“Video CoDec for Audiovisual Services at px64 kbit/s”, incorporated herein by reference) of the ITU. As is known in the art, H.263 is a video source-coding algorithm which uses a hybrid of inter-picture prediction to utilize temporal redundancy and transform coding of the remaining signal to reduce spatial redundancy. Video encoder driver 920 may be additionally configured to support alternative video encoding protocols, such as H.261 common intermediate format (CIF), or proprietary formats.

After the audio and video streams have been encoded, media switch driver 925 prepares the streams for transmissions. Media switch driver software 925 packetizes encoded audio and video streams in accordance with Real-time Protocol (RTP). Media switch software 925 includes instructions for implementing the media stream packetization functions of ITU Recommendations H.225.0 (“Call Signaling Protocols and Media Stream Packetization for Packet-Based Multimedia Communication Systems”) and H.245 (“Control Protocol for Multimedia Communications”) which are incorporated by reference. These recommendations are well known in the art, and hence a detailed description of the functions implemented by communications processes is not included.

In order to transmit audio and video streams a communication protocol is established by the TCP/UDP/IP driver 930, which is a communication protocol, typically embedded in the operating system, for accessing the Internet. TCP is Transmission Control Protocol, UDP is User Datagram Protocol and IP is an Internet Protocol. The TCP/UDP/IP Stack also handles error checking and addressing functions in connection with communications received and transmitted through video/audio input/output 370. TCP/UDP/IP driver 930 is well known in the art, and hence a detailed description of its functions implemented by communications processes is not included here. Alternatively, other protocols such as session initiation protocol (SIP) and 3G Call Control Protocol can be used instead of the TCP/UDP/IP 930.

Since the local area network (LAN) is accessed through the Ethernet via power module 452 or a network card connected to the PCMCIA card slot 475 and 476, a PCMCIA driver 935 for the PCMCIA card and a network or Ethernet driver 940 for the network or Ethernet card are both required. Both the PCMCIA driver 935 and the network or Ethernet driver 940 are well known in the art, and hence a detailed description of their functions is not included.

FIG. 9B shows the software components used to process video and audio streams arriving through a network. The software components include a user interface 950, a network or Ethernet card driver 955, a PCMCIA driver 960, a TCP/UDP/IP STACK driver 965, a media router driver 970, a video/audio decoder 975, and a video/audio CoDec 980. The program flow for processing audio and video streams received from the network is almost the reverse of that for processing audio and video streams received from the videoconference pad's 210 own microphone array 340 and camera 330. The audio and video streams are received through the LAN and accessed through the Ethernet via a network card connected to the PCMCIA card slot. Therefore, PCMCIA drivers 960 are required for operating the PCMCIA card slot and network or Ethernet drivers 955 are required for operating the network or Ethernet card. Furthermore, TCP/UDP/IP stack driver 965 establishes a communication protocol, performs error checking and removes header information from the incoming audio and video streams. The LAN stack will be embedded in the rest of the software running on the multimedia processor.

Media router driver 970, which runs media router 720, separates the modified incoming audio and video streams into their appropriate audio and video components. The audio stream is directed towards the audio decoder 730 whereas the video stream is directed towards the video decoder 740. Audio decoder software 975, which runs audio decoder 730, includes instructions for decoding one or more incoming compressed audio streams received from remote conference endpoints. Audio decoder software 975 may be configured to decode audio streams encoded in accordance with the G.711 protocol, and may additionally be configured to decode audio streams encoded using other protocols, such as G.722, G.728, G.729, G.723.1, and MPEG-1 audio. Additionally, audio decoder software 975 can be configured to apply an echo cancellation algorithm to the incoming audio stream to remove components of the incoming audio signal attributable to acoustic feedback between the loudspeaker and microphone located at the remote conferencing terminal. Since echo cancellation techniques are well known in the art, they need not be discussed here. Video decoder software 975, which runs video decoder 740, includes instructions for decoding local and remote video streams encoded in accordance with the H.261 QCIF protocol. Additionally video decoder software 975 may include instructions for decoding video streams encoded using alternative protocols, such as H.261 CIF, H.263, or proprietary protocols. Finally, the decoded incoming audio and video signals are converted from digital to analog using audio and video CoDec software 980 and transmitted to internal speakers 435, 436 and monitor 310 of the videoconferencing pad 210.

In yet another embodiment, videoconferencing pad 210 may be implemented in a general-purpose, microprocessor-based, notebook computer. The notebook computer may preferably comprise a built-in, digital camera, one or more speakers and audio amplifiers, and a microphone or microphone array. Alternatively, remote speakers and/or microphone arrays may be connected to the notebook computer through, for example, a USB port for improved audio quality. Protocol conversions such as, for example, between H.323 and Audio Codec 97 and/or MPEG may be accomplished by software routines running on the notebook computer. In one particularly preferred embodiment, the notebook computer is equipped with a microprocessor having advanced video processing capabilities such as the Intel Pentium™ 4 processor. In still another embodiment, certain videoconferencing-specific components such as, for example, a pan/tilt/zoom camera and a microphone array are included in a videoconferencing docking station for the notebook computer.

It will also be recognized by those skilled in the art that, while the invention has been described above in terms of preferred embodiments, it is not limited thereto. Various features and aspects of the above-described invention may be used individually or jointly. Further, although the invention has been described in the context of its implementation in a particular environment and for particular applications, those skilled in the art will recognize that its usefulness is not limited thereto and that the present invention can be utilized in any number of environments and implementations.

We claim:

1. A portable videoconferencing system comprising;
a housing;
a microphone within the housing for capturing sounds;
a video camera within the housing for capturing images;
a speaker within the housing for broadcasting sounds;
a video display within the housing for displaying images; and,
a processing unit within the housing coupled to the microphone, the video camera, the speaker and the video display for processing incoming and outgoing audio/video signals.

2. The portable videoconferencing system of claim 1 wherein the microphone comprises an array of acoustic sensors.

3. The portable videoconferencing system of claim 1 wherein the video camera is motor-driven under control of the processing unit for panning and tilting.

4. The portable videoconferencing system of claim 1 wherein the video display is a liquid crystal display.

5. The portable videoconferencing system of claim 1 wherein the video display is a polymer light-emitting diode display.

6. The portable videoconferencing system of claim 1 wherein the video display is a plasma screen.

7. The portable videoconferencing system of claim 1 further comprising a handle mounted to the housing for carrying the videoconferencing system.

8. The portable videoconferencing system of claim 1 further comprising a handle recessed within the housing for carrying the videoconferencing system.

9. The portable videoconferencing system of claim 1 further comprising a battery for supplying power.

10. The portable videoconferencing system of claim 9 wherein the battery is a rechargeable battery.

11. The portable videoconferencing system of claim 1 further comprising a communications module within the housing and connected to the processing unit for wireless communication.

12. The portable videoconferencing system of claim 1 further comprising a memory unit connected to the processing unit and storing instructions for causing the processing unit to process audio/video signals.

13. The portable videoconferencing system of claim 1 further comprising a keypad on the housing for controlling the videoconferencing system.

14. The portable videoconferencing system of claim 1 further comprising an infrared sensor on the housing and a remote control device for controlling the videoconferencing system by sending infrared signals to the infrared sensor.

15. A videoconferencing system, comprising
a first housing;
a microphone within the first housing for capturing sounds;
a video camera within the first housing for capturing images;
a speaker within the first housing for broadcasting sounds;
a video display within the first housing for displaying images;
a connector in the first housing for connecting with a base unit;
a processing unit within the first housing coupled to the microphone, the video camera, the speaker, the connector and the video display for processing incoming and outgoing audio/video signals; and,
a base unit for supporting the first housing and comprising a second housing and a second connector that connects to the first connector when the first housing is supported by the base unit and which conducts incoming and outgoing audio/video signals to the processing unit within the first housing.

16. A videoconferencing system as recited in claim 15 wherein the base unit additionally supplies power through the second connector to the first connector.

17. A videoconferencing system as recited in claim 15 wherein the base unit additionally comprises an H.320 link for videoconferencing over ISDN telecommunication lines.

18. A videoconferencing system as recited in claim 15 wherein the base unit additionally comprises I/O ports for connecting the processing unit to peripheral devices.

19. A videoconferencing system as recited in claim 15 wherein the first connector and second connector are such that the force due to gravity of the first housing upon the base unit when the first housing is supported by the base unit is sufficient to connect the first connector and the second connector.

20. A processor-based, portable videoconferencing system comprising:
a general-purpose notebook computer having a video display, a speaker, a microphone, a video camera and a memory storing instructions for causing the processor to perform protocol conversions for the transmission of audio/video signals over a network.
